(19) United States
(12) Patent Application Publication
(10) Pub. No.: US 2013/0250286 A1
(43) Pub. Date: Sep. 26, 2013

(54) APPARATUS FOR MEASURING PATTERNS ON A REFLECTIVE PHOTOMASK

(71) Applicants: Hak-Seung HAN, Hwaseong-si (KR); In-Kyun SHIN, Yongin-si (KR); Young-Keun YOON, Yongin-si (KR)

(72) Inventors: Hak-Seung HAN, Hwaseong-si (KR); In-Kyun SHIN, Yongin-si (KR); Young-Keun YOON, Yongin-si (KR)

(73) Assignee: SAMSUNG ELECTRONICS CO., LTD., Suwon-si (KR)

(21) Appl. No.: 13/619,072

(22) Filed: Sep. 14, 2012

(30) Foreign Application Priority Data
Mar. 26, 2012 (KR) 10-2012-0030691

(51) Int. Cl. G01N 21/01

(52) U.S. Cl. 356/237.5

(57) ABSTRACT

An apparatus for inspecting, measuring, or inspecting and measuring a reflective photomask may comprise a light illuminating part including a light source and beam shaping part; a stage configured to cause the light generated to be incident at an angle through the beam shaping part; and/or a light detector configured to receive optical image information of the photomask mounted on the stage. An apparatus for inspecting, measuring, or inspecting and measuring a reflective photomask may comprise a light illuminating part including a light source and configured to adjust a progress direction of light from the light source at an angle; a stage in a direction at which the light is irradiated from the light illuminating part at the angle and configured to mount the photomask; a slit plate between the light illuminating part and the stage; and/or a light detector configured to receive image information of the photomask.

### CROSS-REFERENCE TO RELATED APPLICATION(S)

This application claims priority from Korean Patent Application No. 10-2012-0030691, filed on Mar. 26, 2012, in the Korean Intellectual Property Office (KIPO), the entire contents of which are incorporated herein by reference.

### BACKGROUND

1. Field

Example embodiments of the inventive concept may relate to apparatuses and methods for inspecting and/or measuring critical dimensions of patterns of reflective photomasks.

2. Description of Related Art

Reflective photomasks may be used in photolithography processes that form optical patterns on wafers using extreme ultraviolet (EUV) light.

### SUMMARY

Example embodiments of the inventive concept may provide apparatuses for inspecting and/or measuring reflective photomasks using light.

Example embodiments of the inventive concept may provide apparatuses for inspecting and/or measuring optical patterns of reflective photomasks by causing light to be incident to the reflective photomasks at angles.

Example embodiments of the inventive concept may provide methods of inspecting and/or measuring reflective photomasks using light.

Example embodiments of the inventive concept may provide apparatuses for measuring optical patterns of reflective photomasks by causing deep ultraviolet (DUV) light to be incident to the reflective photomasks at angles.

In some example embodiments, an apparatus for measuring patterns on a reflective photomask may comprise a light illuminating part including a light source, configured to generate light, and a beam shaping part; a photomask stage configured to cause the light generated from the light source to be incident at an angle through the beam shaping part; and/or a light detector configured to receive optical image information of the reflective photomask mounted on the photomask stage.

In some example embodiments, the light incident to the photomask stage through the beam shaping part may have an angle with respect to a normal line of a surface of the photomask stage.

In some example embodiments, the light illuminating part may further include a polarization control part.

In some example embodiments, the light source may be configured to generate deep ultra violet (DUV) light having a wavelength of about 193 nm.

In some example embodiments, the beam shaping part may include an optical aperture.

In some example embodiments, the apparatus may further comprise a minor between the light illuminating part and the photomask stage.

In some example embodiments, the minor may include a semitransparent mirror.

In some example embodiments, the apparatus may further comprise a slit plate between the light illuminating part and the photomask stage.

In some example embodiments, the slit plate may include a slit of a bar shape. The photomask stage and the light detector may be configured to move in a direction perpendicular to the slit.

In some example embodiments, the light illuminating part may further include a relay lens between the light source and the beam shaping part.

In some example embodiments, the light detector may include a charge coupled device (CCD).

In some example embodiments, the apparatus may further comprise a pupil lens between the photomask stage and the light detector.

In some example embodiments, an apparatus for measuring patterns on a reflective photomask may comprise a light illuminating part including a light source configured to generate light and configured to adjust a progress direction of the light generated from the light source at an angle; a photomask stage in a direction at which the light is irradiated from the light illuminating part at the angle and configured to mount the reflective photomask; a slit plate between the light illuminating part and the photomask stage; and/or a light detector configured to receive image information of the reflective photomask mounted on the photomask stage.

In some example embodiments, the light illuminating part may further include a beam diffractor.

In some example embodiments, the beam diffractor may include a grating mask.

In some example embodiments, an apparatus for measuring patterns on a reflective photomask may comprise a light illuminating part that includes a light source configured to generate DUV light having a wavelength of about 193 nm; a photomask stage configured to mount the reflective photomask; and/or a light detector configured to receive the DUV light from the light illuminating part that is reflected from the reflective photomask mounted on the photomask stage. The light illuminating part may be configured to cause the DUV light from the light illuminating part to be incident on the reflective photomask at angles other than normal to the reflective photomask.

In some example embodiments, the apparatus may further comprise a beam shaping part. The beam shaping part may include an optical aperture.

In some example embodiments, the apparatus may further comprise a minor between the light illuminating part and the photomask stage.

In some example embodiments, the apparatus may further comprise a semitransparent mirror between the light illuminating part and the photomask stage.

In some example embodiments, the apparatus may further comprise a slit plate between the light illuminating part and the photomask stage.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIGS. 1A to 1F are diagrams conceptually illustrating apparatuses for measuring patterns of reflective photomasks according to some example embodiments of the inventive concept;

FIG. 2A is a diagram conceptually illustrating beam shaping parts according to some example embodiments of the inventive concept;

FIG. 2B is a diagram conceptually illustrating methods of forming beam shaping parts according to some example embodiments of the inventive concept;

FIG. 2C is a diagram illustratively illustrating shapes formed by beam shaping parts according to some example embodiments of the inventive concept;

FIGS. 2D to 2H are diagrams illustrating that DUV light may be adjusted by beam shaping parts at desired (or alternatively, predetermined) angles;

FIGS. 3A and 3B are diagrams conceptually illustrating beam diffractors according to some example embodiments of the inventive concept;

FIGS. 4A to 4J are graphs showing measured results of pattern of reflective photomasks using apparatuses for measuring reflective photomasks according to some example embodiments of the inventive concept;

FIG. 5A is a conceptual diagram explaining that polarization control parts may adjust polarization angles of DUV light in apparatuses for measuring reflective photomasks according to some example embodiments of the inventive concept; and

FIG. 5B is a graph showing measured results of critical dimensions of patterns of reflective photomasks according to polarization angles in an apparatus for measuring reflective photomasks according to some example embodiments of the inventive concept.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

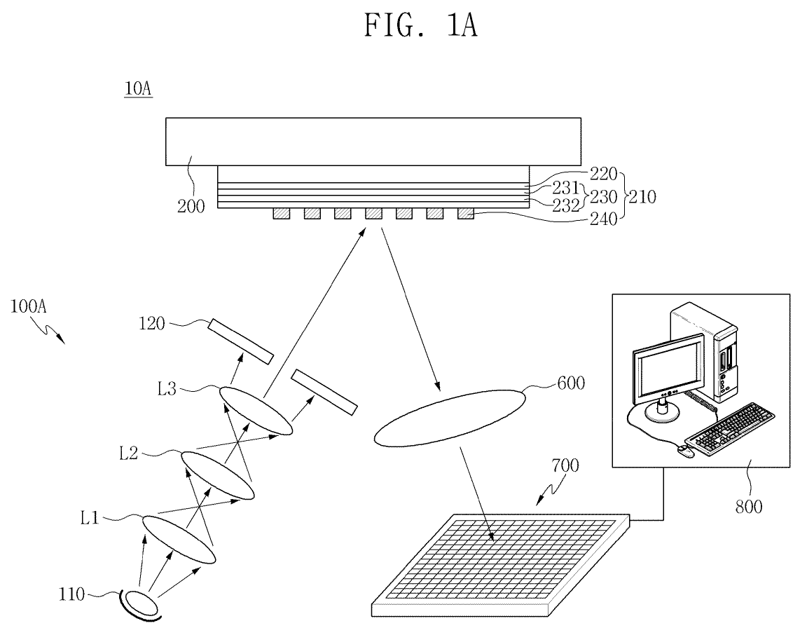

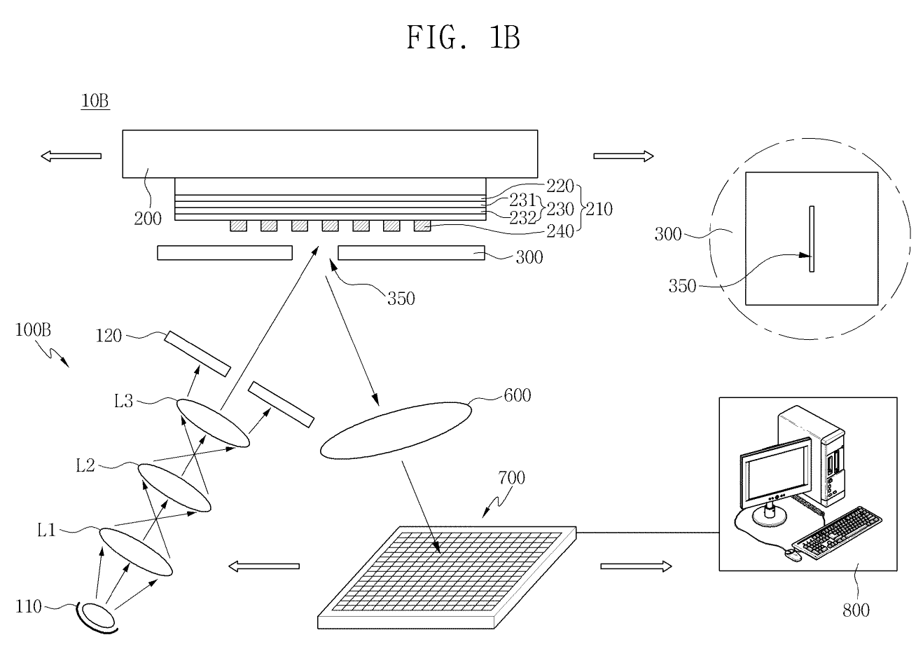

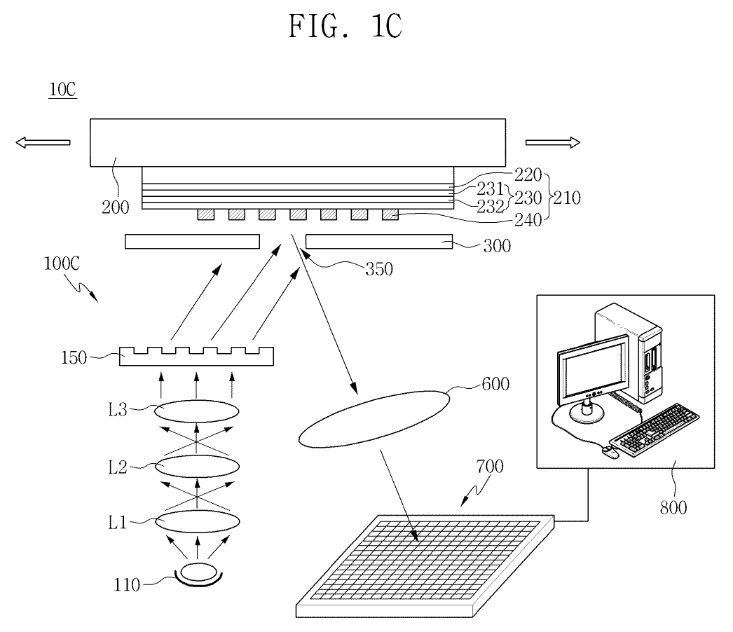

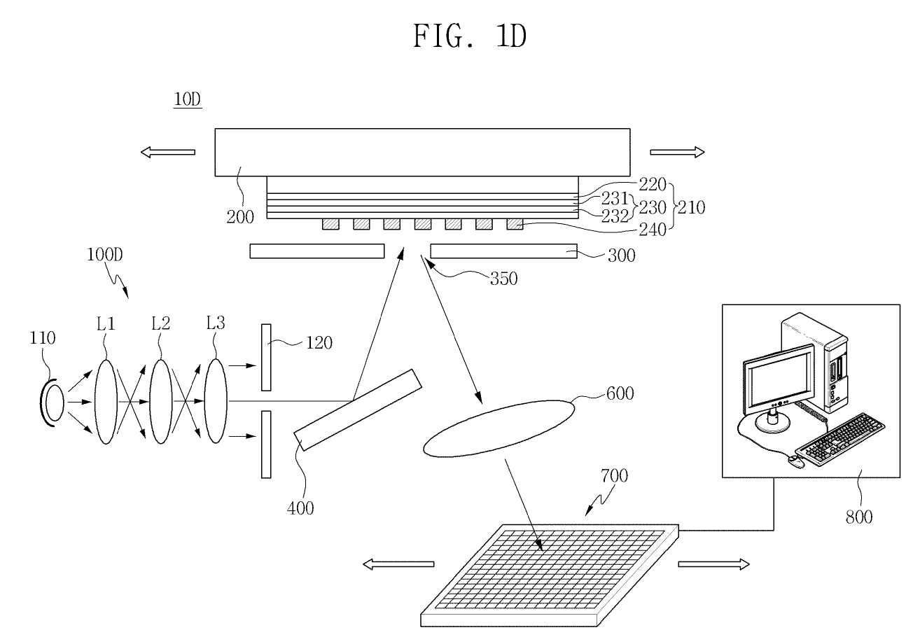

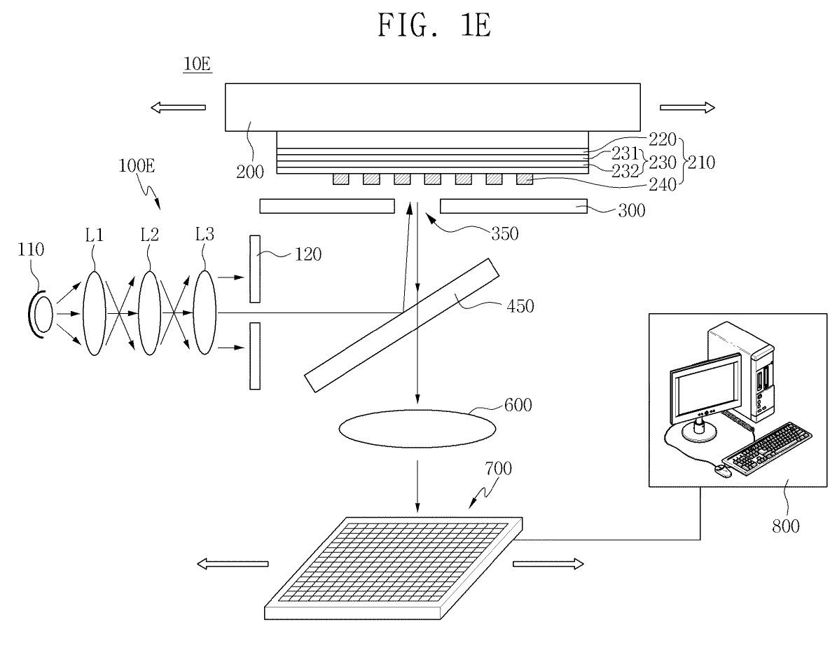

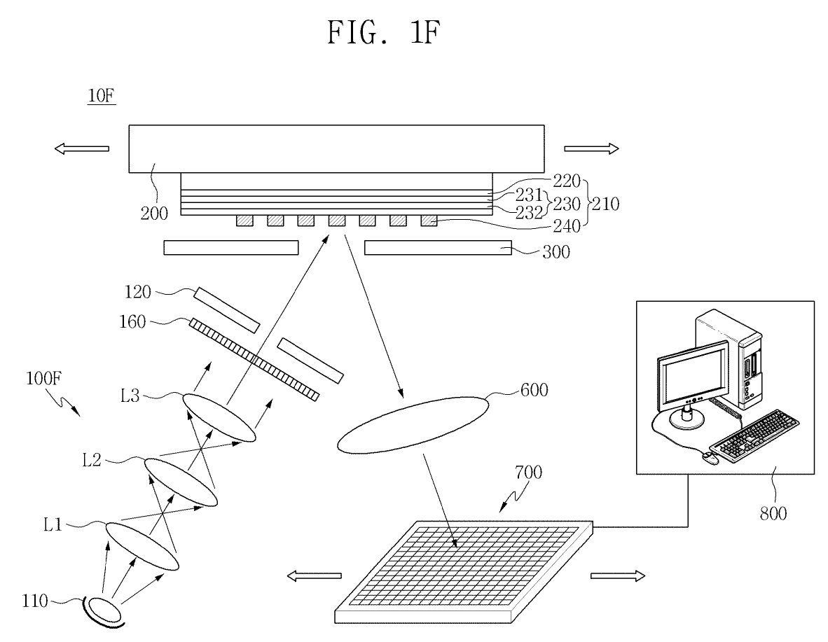

FIGS. 1A to 1F are diagrams illustrating apparatuses 10A to 10F for inspecting and/or measuring a pattern of a reflective photomask according to some example embodiments of the inventive concept.

Referring to FIG. 1A, the apparatus 10A for inspecting and/or measuring a pattern of a reflective photomask according to an embodiment of the inventive concept includes a light illuminating part 100A, a photomask stage 200 and a light detector 700. The apparatus 10A for inspecting and/or measuring a reflective photomask 210 may further include an image analyzing part 800. In order to easily understand example embodiments of the inventive concept, it is assumed and shown that the reflective photomask 210 is mounted on a lower surface of photomask stage 200.

The light illuminating part 100A may include a light source 110 and a beam shaping part 120. The light source 110 may generate light having a wavelength of about 193 nm or more. For example, the light source 110 may generate DUV light having a wavelength of about 193 nm using argon fluoride (ArF) plasma and the like. In addition, the light source 110 may generate ultraviolet rays having wavelengths greater than 193 nm, for example, about 248 nm, 365 nm or the like, using krypton fluoride (KrF) plasma or various ways. Hereinafter, in order to easily understand example embodiments of the inventive concept, it is assumed and described simply and clearly that the light source 110 generates, for example, DUV light having a wavelength of about 193 nm. The beam shaping part 120 may form the DUV light into an arbitrary shape. A shape formed by the beam shaping part 120 will be described in detail later. The light illuminating part 100A may further include relay lenses L1 to L3 installed between the light source 110 and the beam shaping part 120. The relay lenses L1 to L3 may transmit the DUV light to the beam shaping part 120 by reducing loss of intensity of the DUV light generated from the light source 110. For example, the relay lenses L1 to L3 may condense the DUV light so as to prevent the DUV light from escaping to the outside. The light illuminating part 100A may cause the DUV light to be incident to the photomask stage 200 by adjusting the DUV light generated from the light source 110 to an arbitrary angle. For example, the DUV light shaped by the beam shaping part 120 may be irradiated to the photomask stage 200 at various arbitrary angles. The DUV light irradiated from the light illuminating part 100A to the photomask stage 200 may have a desired (or alternatively, predetermined) angle with respect to a normal line of a surface of the photomask stage.

The reflective photomask 210 may be mounted on the lower surface of the photomask stage 200. For example, the photomask stage 200 may include an electrostatic chuck. The reflective photomask 210 may include optical patterns formed in a front surface of a mask substrate 220. For example, the reflective photomask 210 may include a reflecting layer 230 and an absorption pattern 240. The reflecting layer 230 may reflect the EUV light and the DUV light. The reflecting layer 230 may include a first reflecting layer 231 and a second reflecting layer 232 stacked with a multi-layer. For example, the first reflecting layer 231 may include silicon (Si), and the second reflecting layer 232 may include molybdenum (Mo). The absorption pattern 240 may absorb almost all of the EUV light and reflect a little DUV light. The DUV light incident on the front surface of the reflective photomask 210 mounted on the lower surface of the photomask stage 200 may be reflected at a desired (or alternatively, predetermined) angle. The reflected DUV light may have aerial optical image information of optical patterns formed on the front surface of the reflective photomask 210.

The reflected DUV light may be passed through a pupil lens 600 and transmitted to the light detector 700. The light detector 700 may include, for example, a charge coupled device (CCD). When the reflected DUV light is received by the light detector 700 using the CCD, patterns of the reflective photomask 210 may be inspected and/or measured in quantity at the same time. For example, patterns of millions of points or more may be inspected and/or measured at the same time. Generally, when a scanning electro microscopy (SEM) is used, since many areas may not be simultaneously inspected and/or measured, and there are matters of time and cost, it is difficult to inspect and/or measure patterns of hundreds of points or more. However, according to some example embodiments of the inventive concept, if the CCD is used, a relatively large number of patterns may be inspected and/or measured at the same time. In addition, the light detector 700 including the CCD may quickly convert optical image information of the patterns of the reflective photomask 210 to digital information through the reflected DUV light. For example, the light detector 700 may convert the optical image information of the patterns of the reflective photomask 210 into the digital information and then transmit converted digital information to the image analyzing part 800.

The image analyzing part 800 receives the digital information from the light detector 700 and analyzes, inspects, and/or measures the image information of patterns of the reflective photomask 210. For example, the image analyzing part 800 may convert the digital information to visual image information. The image analyzing part 800 inspects and/or measures image of patterns of the reflective photomask 210 based on the visual image information. The image analyzing part 800 may measure a critical dimension (CD) of the patterns of the reflective photomask 210 based on the image information. The image analyzing part 800 displays the image information of the patterns of the reflective photomask 210 on a monitor. For example, the visual image of the patterns of the reflective photomask 210 and inspected and/or measured results for the patterns of the reflective photomask 210 may be displayed in the form of graphics or graphs.

Referring to FIG. 1B, according to some example embodiments of the inventive concept, the apparatus 10B for inspecting and/or measuring a reflective photomask may include a light illuminating part 100B, a photomask stage 200, a light detector 700, and a slit plate 300. The apparatus 10B for inspecting and/or measuring a reflective photomask may further include an image analyzing part 800. The slit plate 300 may cause DUV light incident from the light illuminating part 100B to be selectively incident on the front surface of the reflective photomask 210, and DUV light reflected from the front surface of the reflective photomask 210 to be emitted to the light detector 700. The slit plate 300 includes a slit 350. A shape of the slit plate 300 in a top view or bottom view is conceptually shown. DUV light irradiated from the light illuminating part 100B may be incident on the front surface of the reflective photomask 210 on the photomask stage 200 through the slit 350. The DUV light reflected from the front surface of the reflective photomask 210 may be passed through the slit 350 and a pupil lens 600 and emitted to the light detector 700. The photomask stage 200 and the light detector 700 may be horizontally moved in a direction perpendicular to a direction in which the slit 350 extends (see arrow).

Referring to FIG. 1C, according to some example embodiments of the inventive concept, the apparatus 10C for inspecting and/or measuring a reflective photomask may include a light illuminating part 100C, a photomask stage 200, and a light detector 700, and the light illuminating part 100C may include a light source 110 and a beam diffractor 150. The apparatus 10C for inspecting and/or measuring a reflective photomask may further include an image analyzing part 800. The light illuminating part 100C may further include relay lenses L1 to L3. The apparatus 10C for inspecting and/or measuring a reflective photomask may further include a slit plate 300. The beam diffractor 150 may diffract DUV light at various angles. A diffracting angle of the DUV light may be varied depending on material or shape of the beam diffractor 150. For example, the DUV light passed through the beam diffractor 150 may be diffracted at a surface of the beam diffractor 150 at various angles. The diffracted DUV light may be passed through the slit 350 at a desired (or alternatively, predetermined) angle and incident on the front surface of the reflective photomask 210. The beam diffractor 150 will be described in detail later.

Referring to FIG. 1D, according to some example embodiments of the inventive concept, the apparatus 10D for inspecting and/or measuring a reflective photomask includes a light illuminating part 100D, a minor 400, a photomask stage 200, and a light detector 700. The apparatus 10D for inspecting and/or measuring a reflective photomask may further include an image analyzing part 800. The apparatus 10D for inspecting and/or measuring a reflective photomask may further include a slit plate 300. The minor 400 may be installed on the light illuminating part 100D and the photomask stage 200. DUV light irradiated from the light illuminating part 100D may be reflected to the mirror 400 and incident on a surface of the reflective photomask 210 at a desired (or alternatively, predetermined) angle. A portion of the DUV light reflected from the front surface of the reflective photomask 210 may be passed through a pupil lens 600 and transmitted to the light detector 700. The mirror may be tilted or rotated. For example, the minor 400 may adjust the DUV light received from the light illuminating part 100D at a desired (or alternatively, predetermined) angle and cause the adjusted DUV light to be incident on the front surface of the reflective photomask 210.

Referring to FIG. 1E, according to some example embodiments of the inventive concept, the apparatus 10E for inspecting and/or measuring a reflective photomask may include a light illuminating part 100E, a photomask stage 200, a semitransparent mirror 450, and the light detector 700. The apparatus 10E for inspecting and/or measuring a reflective photomask may further include an image analyzing part 800. The apparatus 10E for inspecting and/or measuring a reflective photomask may further include a slit plate 300. DUV light irradiated from the light illuminating part 100E may be reflected to the semitransparent minor 450 and incident on the front surface of the reflective photomask 210. A portion of the DUV light reflected from the front surface of the reflective photomask 210 may be passed through the semitransparent mirror 450 and a pupil lens 600 and transmitted to the light detector 700. A beam shaping part 120 of the light illuminating part 100E may cause the DUV light to be incident on the semitransparent mirror 450 at a desired (or alternatively, predetermined) angle. The semitransparent mirror 450 may also be tilted or rotated. For example, the semitransparent minor 450 may adjust the DUV light received from the light illuminating part 100E at a desired (or alternatively, predetermined) angle and cause the adjusted DUV light to be incident on the front surface of the reflective photomask 210.

Referring to FIG. 1F, according to some example embodiments of the inventive concept, the apparatus 1OF for inspecting and/or measuring a reflective photomask includes a light illuminating part 100F, a photomask stage 200, and a light detector 700, and the light illuminating part 100F may further include a polarization control part 160. The apparatus 10F for inspecting and/or measuring a reflective photomask may further include an image analyzing part 800. The apparatus 10F for inspecting and/or measuring a reflective photomask may further include a slit plate 300. The polarization control part 160 may adjust bias of the DUV light, that is, an oscillating direction. For example, the oscillating direction of the DUV light may be adjusted to have a desired (or alternatively, predetermined) angle formed in an extension direction of the patterns of the reflective photomask 210. The polarization control part 160 will be described in detail later.

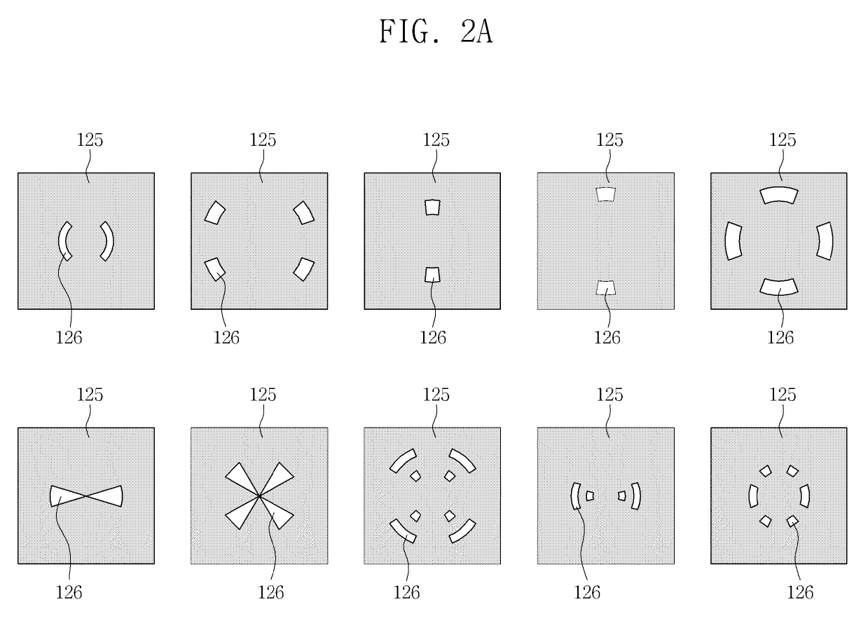

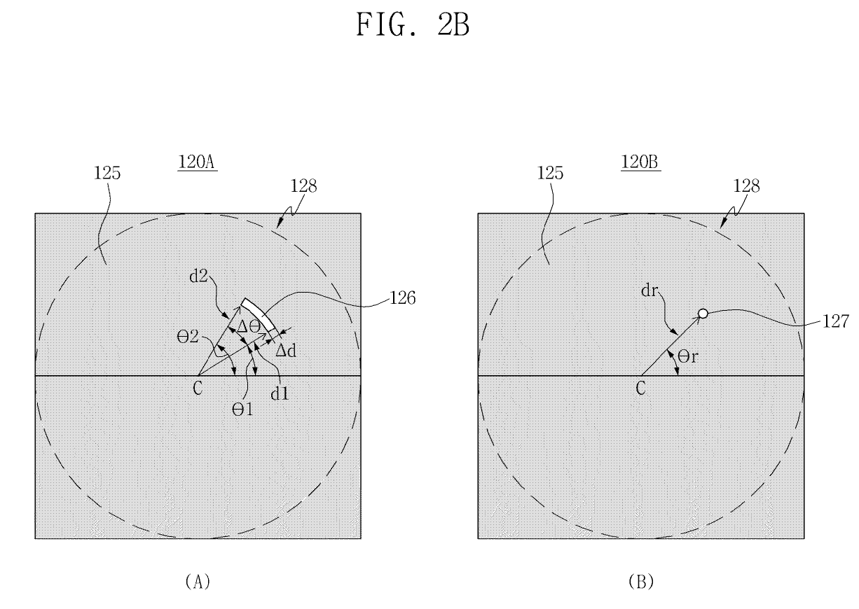

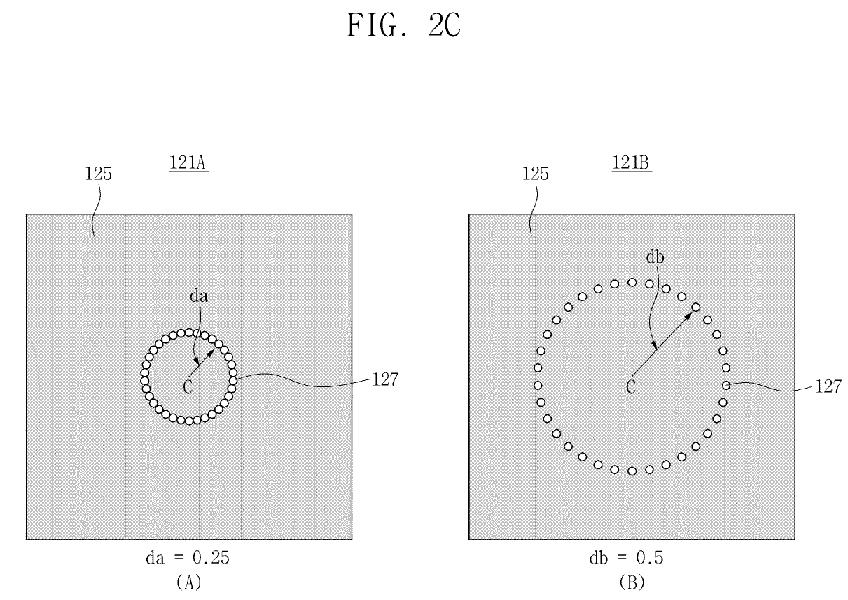

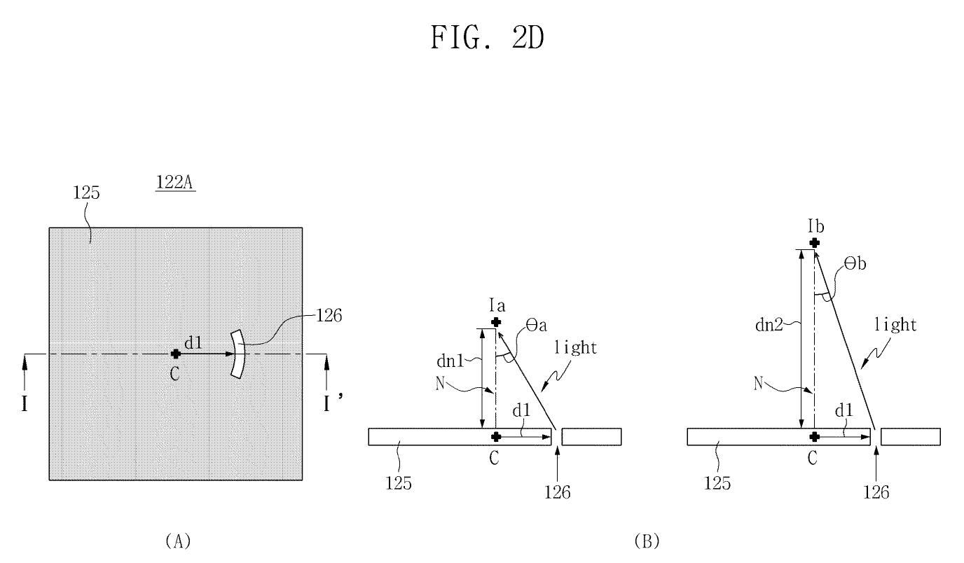

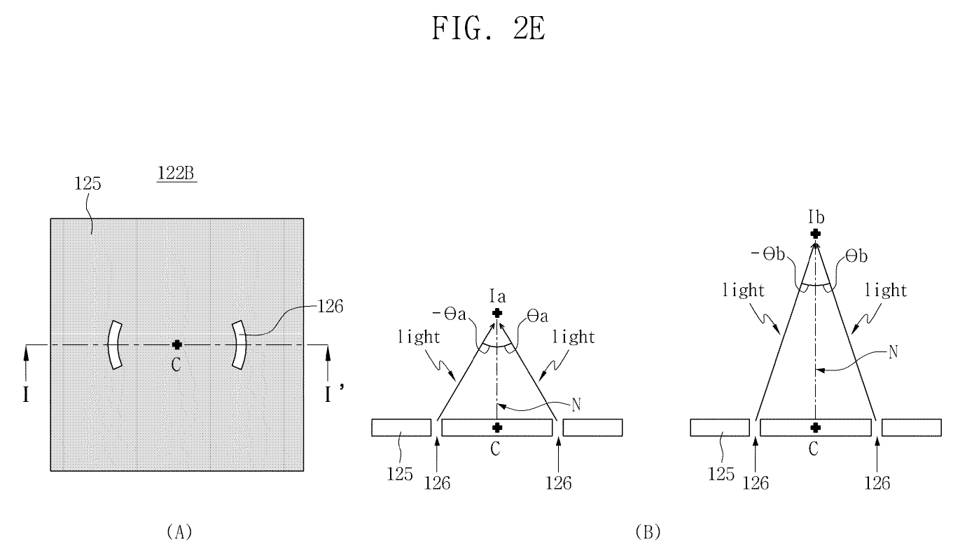

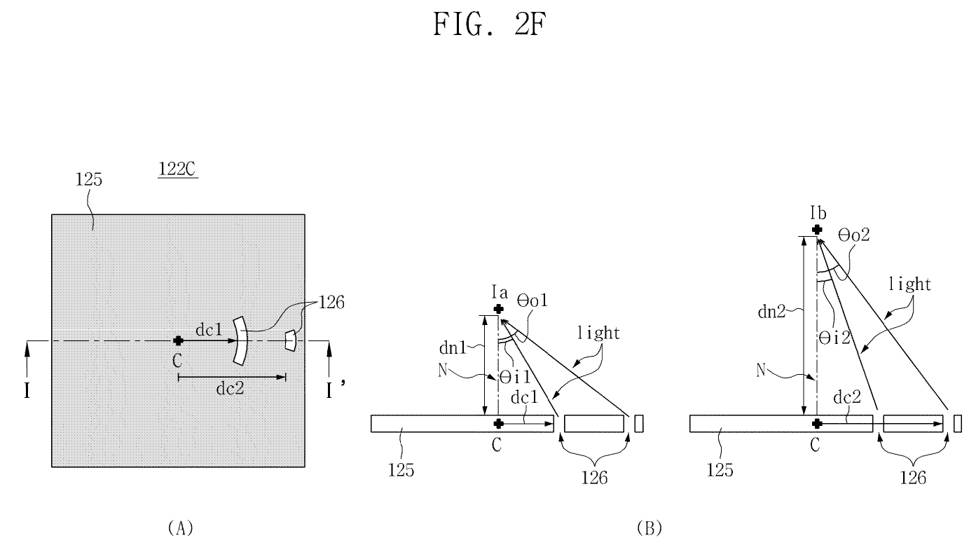

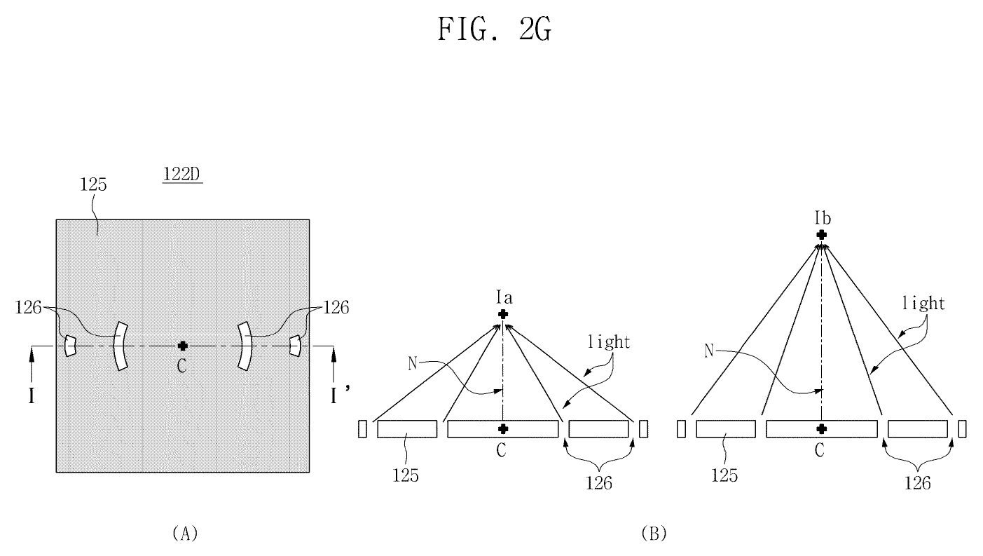

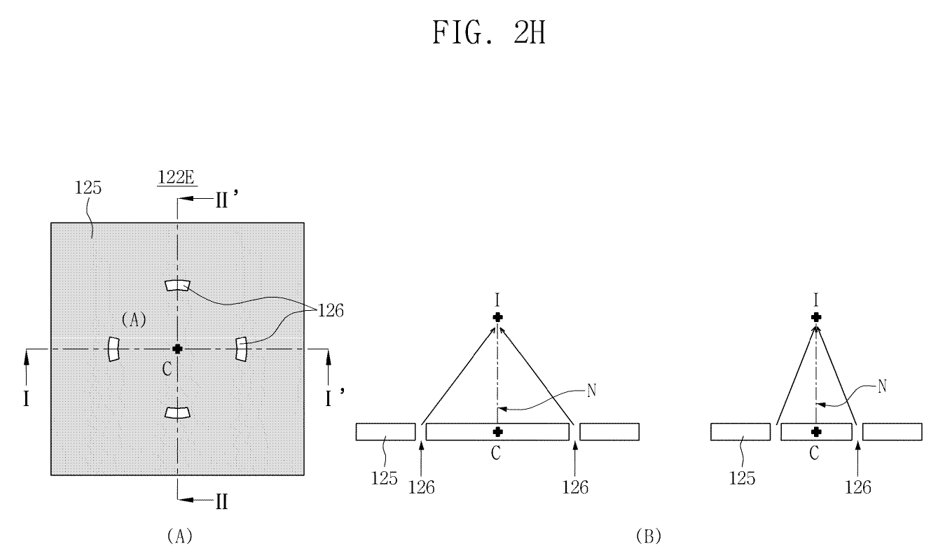

FIG. 2A is a diagram conceptually illustrating a beam shaping part 120 according to some example embodiments of the inventive concept. Referring to FIG. 2A, the beam shaping part 120 according to some example embodiments of the inventive concept includes a blind area 125 and an aperture area 126. The blind area 125 may block DUV light. The aperture area 126 is an aerial space and passes the DUV light. Thus, the DUV light passed through the beam shaping part 120 may have a beam shape corresponding to the aperture area 126. However, since the DUV light passed through the aperture area 126 may be diffracted, it may not have the same shape as the aperture area 126. The DUV light passed through the aperture area 126 may be incident on the reflective photomask 210 and the mirror 400, or the semitransparent mirror 450, at a desired (or alternatively, predetermined) angle. A technical concept of off-axis illumination (OAI) technology may be applied to the beam shaping part 120. For example, the beam shaping part 120 may be formed by suitably combining a dipole optical aperture, a quardrupole optical aperture, an annular optical aperture, and the like. For example, the beam shaping part 120 may be formed from a variety of shapes such as disar, quasar, cross-pole, annular, di-annular and quad-annular, C-quad, or a combination thereof.

FIG. 2B is a diagram conceptually illustrating methods of forming beam shaping parts 120A and 120B according to some example embodiments of the inventive concept. Referring to FIG. 2B (A), the beam shaping part 120A according to some example embodiments of the inventive concept may have an aperture area 126 corresponding to a desired (or alternatively, predetermined) offset angle range (Δθ=θ2−θ1) and a desired (or alternatively, predetermined) offset distance range (Δd=d2−d1) from a central point C. Referring to FIG. 2B (B), the beam shaping part 120B according to some example embodiments of the inventive concept may include an unit aperture area 127 corresponding to a desired (or alternatively, predetermined) offset angle θr and a desired (or alternatively, predetermined) offset distance dr from the central point C. For example, in this embodiment, assuming that a radius of a virtual circle 128 inscribed in four sides of the beam shaping part 120B from a length of one side of the beam shaping part 120B, that is, from the central point C of the beam shaping part 120B, is 1, it may be explained that the unit aperture area 127 of (B) is formed at a position having an offset angle θr of 45° and an offset distance dr of 0.5. Illustratively, it is assumed and shown that the unit aperture area 127 is a circle shape having a width of 2% of a radius of a virtual circle 128 inscribed in four sides of the beam shaping part 120B. However, the unit aperture area 127 may have a variety of shapes and sizes. For example, the unit aperture area 127 may be formed from a variety of shapes such as a rectangular, a bar, an arc, circular arc, a folding fan, or any other shape.

FIG. 2C is a diagram illustratively illustrating shapes in which beam shaping parts 121A and 121B are formed according to some example embodiments of the inventive concept. Referring to FIG. 2C (A), the beam shaping part 121A according to some example embodiments of the inventive concept may include an aperture area 127 that has an offset distance da of 0.25 and arranged from 0° to 350° at intervals of 10°. Referring to FIG. 2C (B), the beam shaping part 121B according to some example embodiments of the inventive concept may include an aperture area 127 that has an offset distance db of 0.5 and arranged from 0° to 350° at intervals of 10°. The beam shaping parts 121A and 121B shown in FIG. 2C may include unit apertures having a difference of the offset distances da and db regardless of an offset angle θ.

FIGS. 2D to 2H are diagrams explaining that DUV light may be adjusted by beam shaping parts 122A to 122E at a desired (or alternatively, predetermined) angle. In each drawing, (A) is a top view of the beam shaping parts 122A to 122E, and (B) is a sectional view taken along line I-I′. Referring to FIGS. 2D to 2H, the beam shaping parts 122A to 122E may include a blind area 125 and an aperture area 126.

Referring to FIG. 2D, the beam shaping part 122A may have an aperture area 126 offset by a certain distance d1 at one side. DUV light passed through the offset aperture area 126 may diagonally intersect with a virtual intersecting point I located on a normal line N passing through a central point C of the beam shaping part 122A. For example, the DUV light passed through the offset aperture area 126 may have a desired (or alternatively, predetermined) angle θa with the normal line N passing through the central point C of the beam shaping part 122A. The angle θa may be set according to an offset distance d1 of the aperture area 126 spaced from the central point C of the beam shaping part 122A and a spaced distance dn1 of the virtual intersecting point I located on the normal line N from the central point C of the beam shaping part 122A. Since the DUV light passed through the offset aperture area 126 is progressed to a plane wave of a concentric shape, the virtual intersecting point I may be set to an arbitrary position, or spaced distances dn1 and dn2 between the beam shaping part 122A and the virtual intersecting point I, such that angles θa and θb between the DUV light and the normal line N may be variously adjusted. In addition, the position of the virtual intersecting point I may be fixed and the offset distance d1 may be varied, such that the angles θa and θb with the normal line N may be variously adjusted.

Referring to FIG. 2E, the beam shaping part 122B may have an aperture area 126 symmetrically offset in a horizontal direction. Referring again to FIG. 2C, DUV light passed through the offset aperture area 126 may diagonally intersect with the virtual intersecting point I located on the normal line N passing through the central point C of the beam shaping part 122B. Thus, the DUV light may have symmetrical angles ±θa and ±θb and be incident to the photomask stage 200 from both sides.

Referring to FIG. 2F, the beam shaping part 122C may have a plurality of aperture areas 126 offset in one direction. Thus, the DUV light may be incident to the photomask stage 200 with various angles (θi1, θi2, θo1, θo2) according to the offset distances dc1 and dc2.

Referring to FIG. 2G, the beam shaping part 122D may have a plurality of aperture areas 126 symmetrically offset in a horizontal direction. Thus, the DUV light may be incident to the photomask stage 200 with a plurality of symmetrical angles.

Referring to FIG. 2H, the beam shaping part 122E may have a plurality of aperture areas 126 symmetrically offset in a horizontal direction I-I′ and a vertical direction II-II′. Thus, the DUV light may be incident to the photomask stage 200 with a symmetrical angle according to the offset distances from the horizontal direction and the vertical direction.

Referring to FIGS. 2A to 2H, it is fully understood that the beam shaping parts 120, 120A, 120B, 121A, 121B, and 122A-122E may have aperture areas 126 and/or unit aperture areas 127 having various sizes and variously arranged.

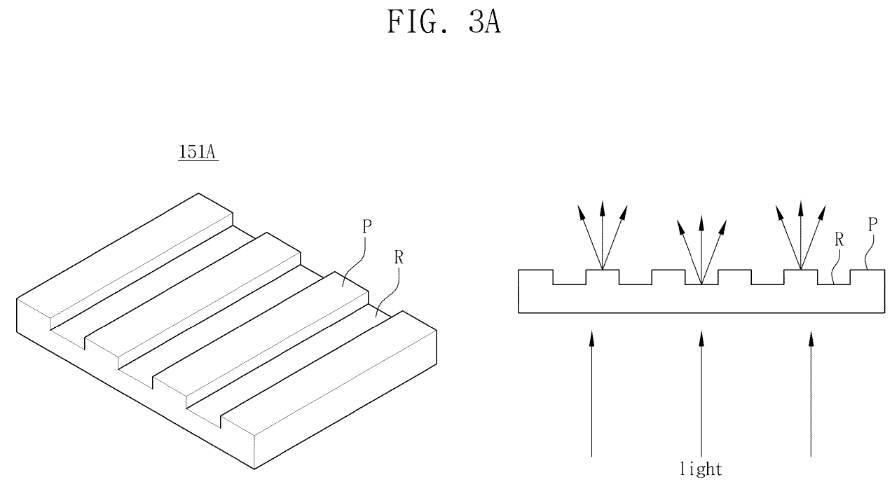

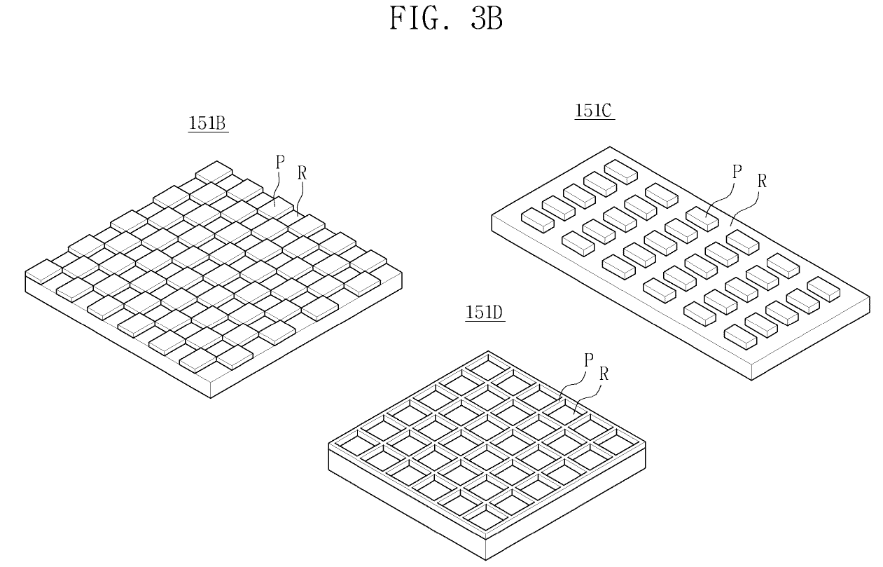

FIGS. 3A and 3B are diagrams conceptually illustrating beam diffractors according to some example embodiments of the inventive concept. Referring to FIG. 3A, according to some example embodiments of the inventive concept, a beam diffractor 150 may include a line-type grating mask 151A. The line-type grating mask 151A may include a plurality of parallel line-type recessed portions R and protruding portions P. The line-type grating mask 151A may diffract the DUV light in the form of one dimension, for example, a fan shape. Thus, the DUV light passed through the line-type grating mask 151A may be infinitely diffracted in the form of the fan shape such as 0-order diffracted light, ±1-order diffracted light, ±2-order diffracted light, and the like. In the drawing, only the 0-order diffracted light and the ±1-order diffracted are shown. Referring to FIG. 1C, the ±1-order diffracted light may be incident on the front surface of the reflective photomask 210 at a desired (or alternatively, predetermined) angle. A difference in level between the recessed portions R and protruding portions P of the line-type grating mask 151A may be considered to set a relationship of destructive interference and constructive interference of the diffracted light. For example, in a case in which a phase difference of diffracted light passed through the recessed portions R and diffracted light passed through the protruding portions P of the line-type grating mask 151A is between (¼)*π and (¾)*π, destructive interference may occur. In addition, in a case in which a phase difference of diffracted light passed through the recessed portions R and diffracted light passed through the protruding portions P of the line-type grating mask 151A is less than (¼)*π or exceeds (¾)*π, constructive interference may occur. In order to obtain the required diffraction angle, widths and/or intervals of the recessed portions R and the protruding portions P of the line-type grating mask 151A may be variously adjusted. For example, as widths and intervals of the recessed portions R and/or the protruding portions P of the line-type grating mask 151A decrease, the diffraction angle may increase.

Referring to FIG. 3B, the beam diffractor 150 according to some example embodiments of the inventive concept may include any one of a checker board-type grating mask 151B, an island-type grating mask 151C or a lattice-type grating mask 151D. The checker board-type grating mask 151B, the island-type grating mask 151C or the lattice-type grating mask 151D includes the plurality of recessed portions R and protruding portions P alternating in two directions. The checker board-type grating mask 151B, the island-type grating mask 151C or the lattice-type grating mask 151D may diffract the DUV light in two dimensions, for example, four directions.

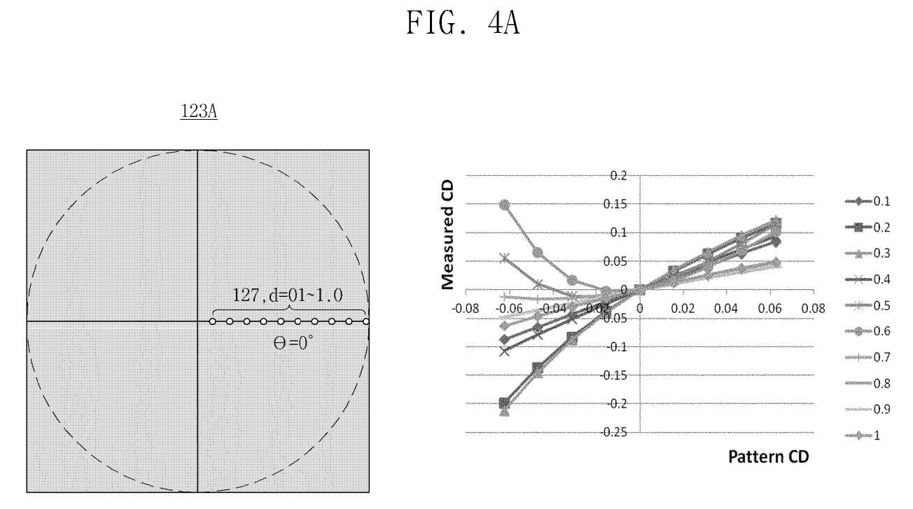

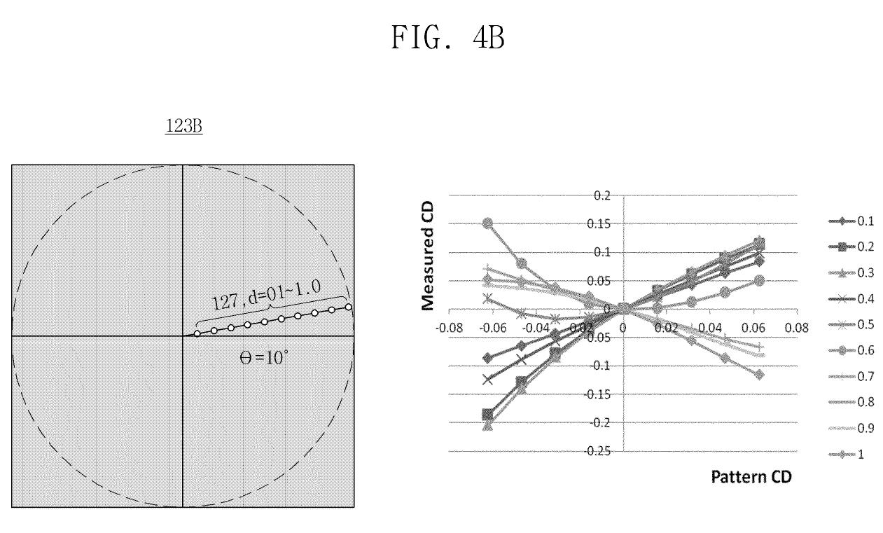

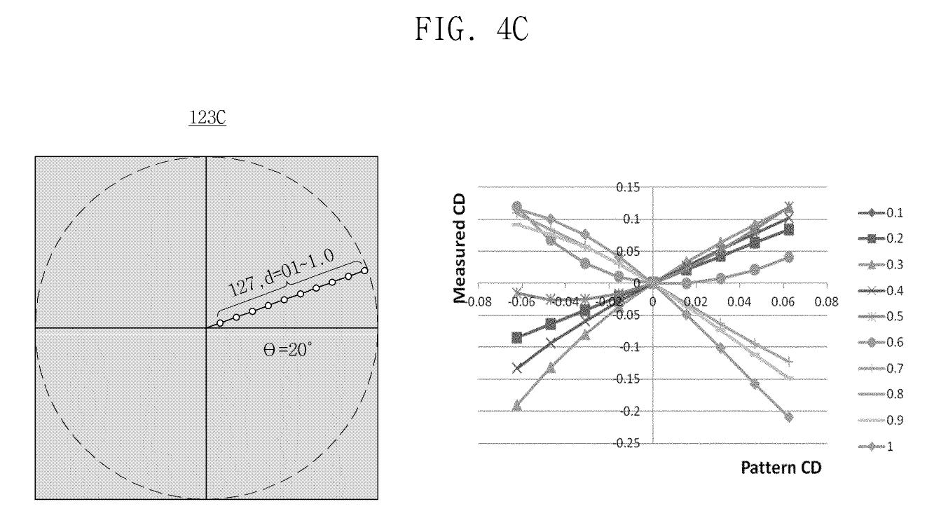

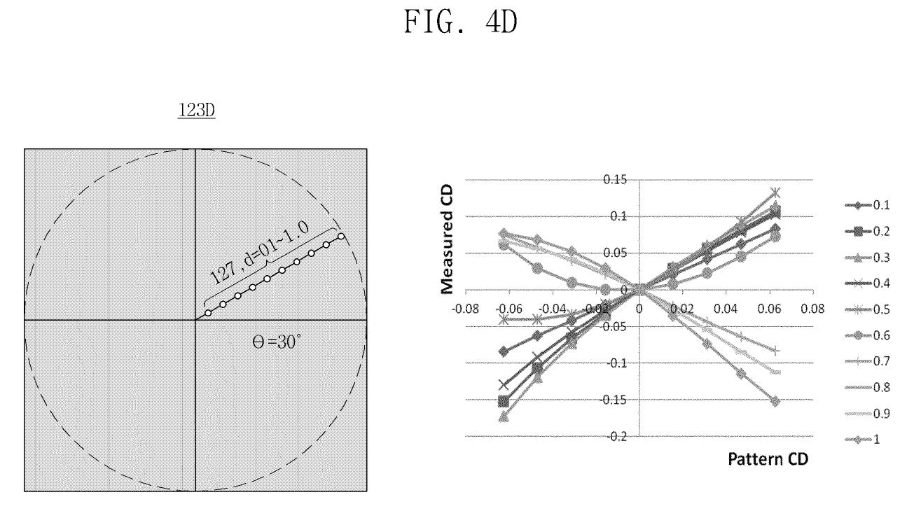

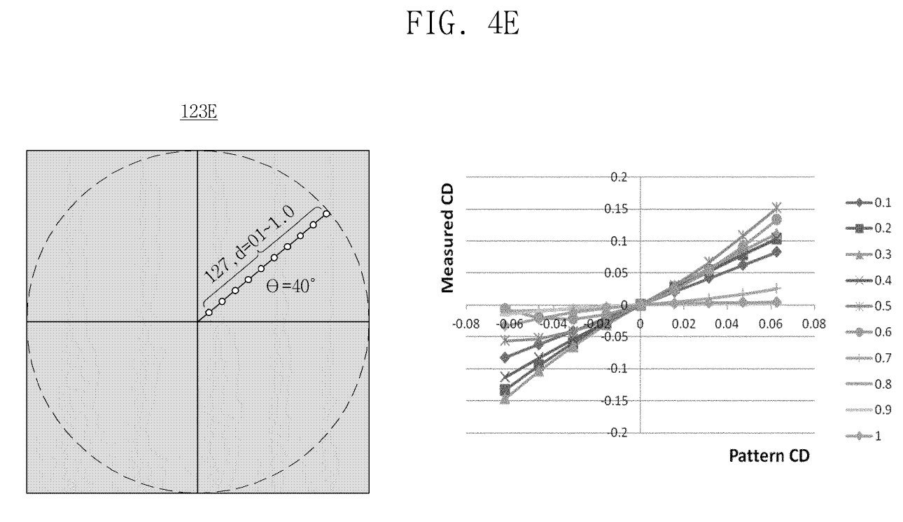

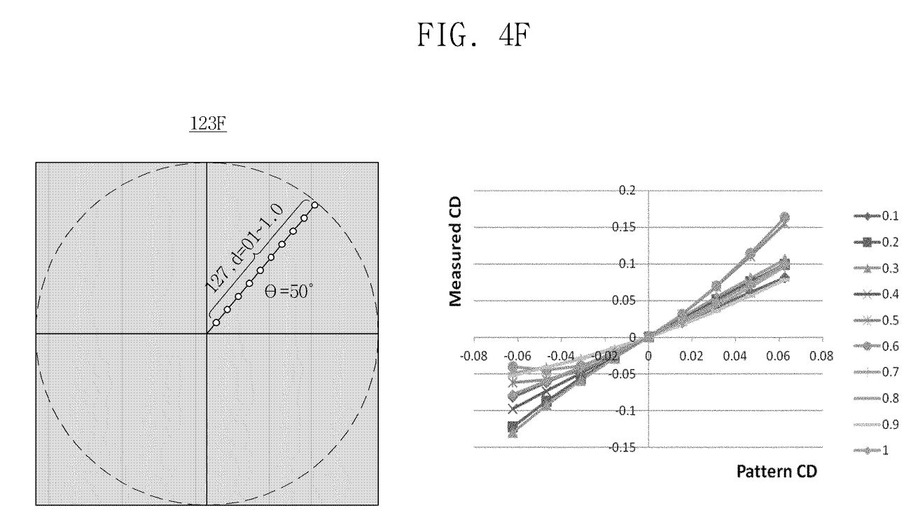

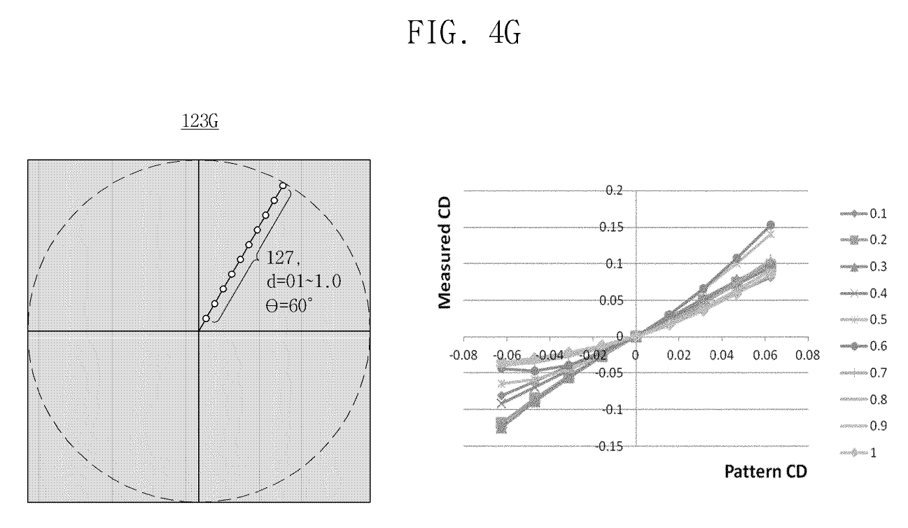

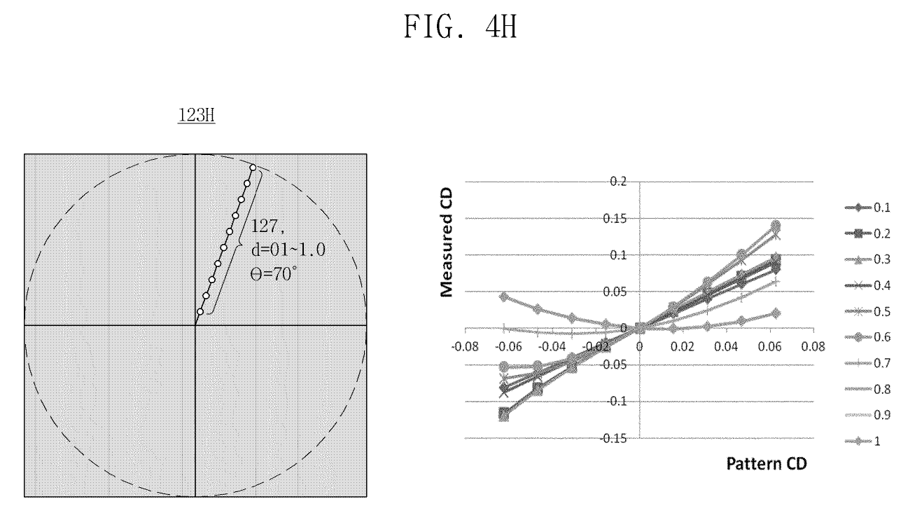

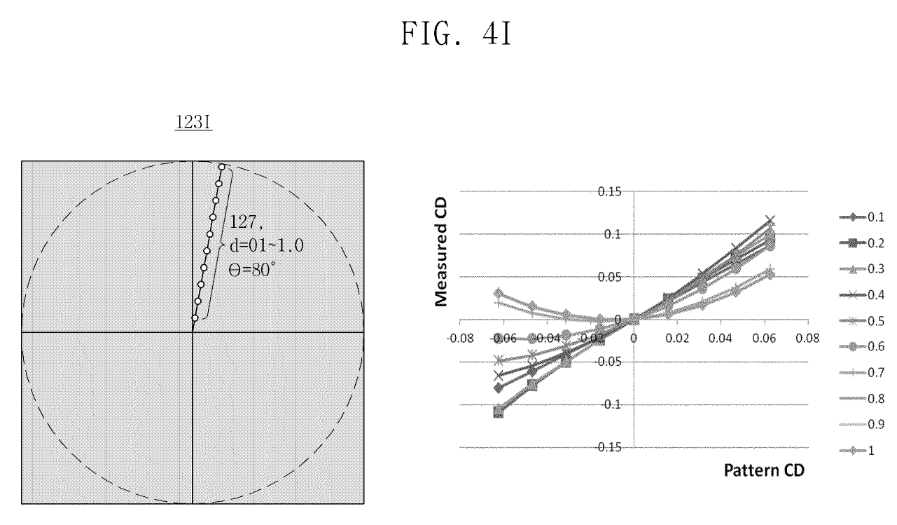

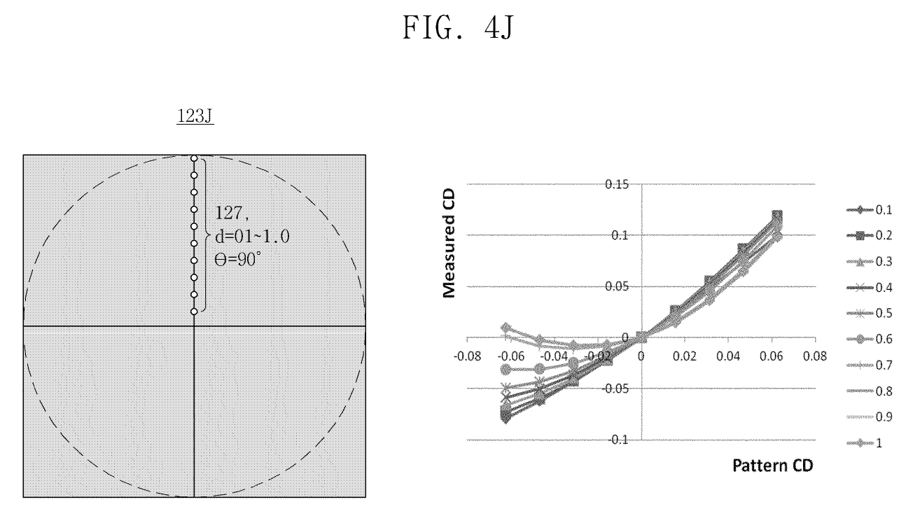

FIGS. 4A to 4J are graphs showing measured results of a pattern of a reflective photomask using an apparatus for inspecting and/or measuring a reflective photomask according to some example embodiments of the inventive concept. As an example, a reflective photomask with line and space patterns of 128 nm half-pitch has been used in the experiment. In the drawings, (A) indicates diagrams conceptually illustrating a beam shaping part used in this experiment, and (B) indicates a graph of measured results. The X-axis of the graph indicates increasing or decreasing percentage from an origin (0), which is set as a critical dimension of patterns. For example, 0.02 increase means to be wider by a width corresponding to 2% of the critical dimension, and 0.02 decrease means to be narrower by a width corresponding to 2% of the critical dimension. The Y-axis of the graph indicates measured values of a changed critical dimension.

FIG. 4A is a graph showing the results of split-measuring a critical dimension of patterns of the reflective photomask 210, by further referring to FIGS. 2B and 2C and using the beam shaping part 123A having unit aperture areas 127 located at an offset angle θ of 0° passing the central point C, that is, on a horizontal line and arranged from 0.1 to 1.0 offset distance at 0.1 intervals. Referring to FIG. 4A, linear results in which critical dimensions of the patterns of the reflective photomask 210 are measured using unit aperture areas 127 located at offset distances d between 0.1 and 0.4 and between 0.8 and 1.0 are shown. Thus, when the beam shaping part 123A having unit aperture areas 127 located at an offset angle θ of 0° and offset distances d between 0.1 and 0.4 or between 0.8 and 1.0 is used, the critical dimension of the pattern of the reflective photomask 210 may be measured using the DUV light.

FIG. 4B is a graph showing the results of split-measuring a critical dimension of patterns of the reflective photomask 210, by further referring to FIGS. 2B and 2C and using the beam shaping part 123B having unit aperture areas 127 located on an extending line of an offset angle θ of 10° passing the central point C and arranged from 0.1 to 1.0 offset distance d at 0.1 intervals. Referring to FIG. 4B, linear results in which critical dimensions of patterns of the reflective photomask 210 are measured using unit aperture areas 127 located at offset distances d between 0.1 and 0.4 are shown. Thus, when the beam shaping part 123B having unit aperture areas 127 located at an offset angle θ of 10° and offset distances d between 0.1 and 0.4 is used, the critical dimension of the pattern of the reflective photomask 210 may be relatively accurately measured using the DUV light. In addition, when the beam shaping part 123B having unit aperture areas 127 located at offset distances d between 0.7 and 1.0 is used, it may be seen that a change of the critical dimension of the pattern and the measured value are indicated to have a linear inverse slope. If a linear result is indicated, even a case of the inverse slope, the critical dimension of the pattern of the reflective photomask 210 may be relatively accurately measured using the DUV light according to some example embodiments of the inventive concept.

FIG. 4C is a graph showing the results of split-measuring a critical dimension of patterns of the reflective photomask 210, by further referring to FIGS. 2B and 2C and using the beam shaping part 123C having unit aperture areas 127 located on an extending line of an offset angle θ of 20° passing the central point C and arranged from 0.1 to 1.0 offset distance d at 0.1 intervals. Referring to FIG. 4B, linear results in which critical dimensions of patterns of the reflective photomask 210 are measured using unit aperture areas 127 located at offset distances d between 0.2 and 0.4, are shown. Thus, when the beam shaping part 123C having unit aperture areas 127 located at an offset angle θ of 20° and offset distances d between 0.1 and 0.4 or between 0.8 and 1.0 is used, the critical dimension of the pattern of the reflective photomask 210 may be relatively accurately measured using the DUV light. In addition, when the beam shaping part 123C having unit aperture areas 127 located at offset distances d between 0.7 and 1.0 is used, it may be seen that a change of the critical dimension of the pattern and the measured value are indicated to have a linear inverse slope. If a linear result is indicated, even a case of the inverse slope, the critical dimension of the pattern of the reflective photomask 210 may be relatively accurately measured using the DUV light according to some example embodiments of the inventive concept.

FIG. 4D is a graph showing the results of split-measuring a critical dimension of patterns of the reflective photomask 210, by further referring to FIGS. 2B and 2C and using the beam shaping part 123D having unit aperture areas 127 located on an extending line of an offset angle θ of 30° passing the central point C and arranged from 0.1 to 1.0 offset distance d at 0.1 intervals. Referring to FIG. 4D, linear results in which critical dimensions of patterns of the reflective photomask 210 are measured using unit aperture areas 127 located at offset distances d between 0.1 and 0.4, are shown. Thus, when the beam shaping part 123D having unit aperture areas 127 located at an offset angle θ of 30° and offset distances d between 0.1 and 0.4 is used, the critical dimension of the pattern of the reflective photomask 210 may be relatively accurately measured using the DUV light. In addition, when the beam shaping parts having unit aperture areas 127 located at offset distances d between 0.7 and 1.0 is used, it may be seen that a change of the critical dimension of the pattern and the measured value are indicated to have a linear inverse slope. If a linear result is indicated, even a case of the inverse slope, the critical dimension of the pattern of the reflective photomask 210 may be relatively accurately measured using the DUV light according to some example embodiments of the inventive concept.

FIG. 4E is a graph showing the results of split-measuring a critical dimension of patterns of the reflective photomask 210, by further referring to FIGS. 2B and 2C and using the beam shaping part 123E having unit aperture areas 127 located on an extending line of an offset angle θ of 40° passing the central point C and arranged from 0.1 to 1.0 offset distance d at 0.1 intervals. Referring to FIG. 4E, linear results in which critical dimensions of patterns of the reflective photomask 210 are measured using unit aperture areas 127 located at offset distances d between 0.1 and 0.4, are shown. Thus, when the beam shaping part 123E having unit aperture areas 127 located at an offset angle θ of 40° and offset distances d between 0.1 and 0.4 is used, the critical dimension of the pattern of the reflective photomask 210 may be relatively accurately measured using the DUV light.

FIG. 4F is a graph showing the results of split-measuring a critical dimension of patterns of the reflective photomask 210, by further referring to FIGS. 2B and 2C and using the beam shaping part 123F having unit aperture areas 127 located on an extending line of an offset angle θ of 50° passing the central point C and arranged from 0.1 to 1.0 offset distance d at 0.1 intervals. Referring to FIG. 4F, linear results in which critical dimensions of patterns of the reflective photomask 210 are measured using unit aperture areas 127 located at offset distances d between 0.1 and 0.4 and between 0.7 and 1.0, are shown. Thus, when the beam shaping part 123F having unit aperture areas 127 located at an offset angle θ of 50° and offset distances d between 0.1 and 0.4 and between 0.7 and 1.0 is used, the critical dimension of the pattern of the reflective photomask 210 may be relatively accurately measured using the DUV light.

FIG. 4G is a graph showing the results of split-measuring a critical dimension of patterns of the reflective photomask 210, by further referring to FIGS. 2B and 2C and using the beam shaping part 123G having unit aperture areas 127 located on an extending line of an offset angle θ of 60° passing the central point C and arranged from 0.1 to 1.0 offset distance d at 0.1 intervals. Referring to FIG. 4G, linear results in which critical dimensions of patterns of the reflective photomask 210 are measured using unit aperture areas 127 located at offset distances d between 0.1 and 0.4, are shown. Thus, when the beam shaping part 123G having unit aperture areas 127 located at an offset angle θ of 60° and offset distances d between 0.1 and 0.4 is used, the critical dimension of the pattern of the reflective photomask 210 may be relatively accurately measured using the DUV light.

FIG. 4H is a graph showing the results of split-measuring a critical dimension of patterns of the reflective photomask 210, by further referring to FIGS. 2B and 2C and using the beam shaping part 123H having unit aperture areas 127 located on an extending line of an offset angle θ of 70° passing the central point C and arranged from 0.1 to 1.0 offset distance d at 0.1 intervals. Referring to FIG. 4H, linear results in which critical dimensions of patterns of the reflective photomask 210 are measured using unit aperture areas 127 located at offset distances d between 0.1 and 0.4, are shown. Thus, when the beam shaping part 123H having unit aperture areas 127 located at an offset angle θ of 70° and offset distances d between 0.1 and 0.4 is used, the critical dimension of the pattern of the reflective photomask 210 may be relatively accurately measured using the DUV light.

FIG. 4I is a graph showing the results of split-measuring a critical dimension of patterns of the reflective photomask 210, by further referring to FIGS. 2B and 2C and using the beam shaping part 123I having unit aperture areas 127 located on an extending line of an offset angle θ of 80° passing the central point C and arranged from 0.1 to 1.0 offset distance d at 0.1 intervals. Referring to FIG. 4I, linear results in which critical dimensions of patterns of the reflective photomask 210 are measured using unit aperture areas 127 located at offset distances d between 0.1 and 0.5, are shown. Thus, when the beam shaping part 1231 having unit aperture areas 127 located at an offset angle θ of 80° and offset distances d between 0.1 and 0.5 is used, the critical dimension of the pattern of the reflective photomask 210 may be relatively accurately measured using the DUV light.

FIG. 4J is a graph showing the results of split-measuring a critical dimension of patterns of the reflective photomask 210, by further referring to FIGS. 2B and 2C and using the beam shaping part 123J having unit aperture areas 127 located on an extending line of an offset angle θ of 90° passing the central point C and arranged from 0.1 to 1.0 offset distance d at 0.1 intervals. Referring to FIG. 4J, linear results in which critical dimensions of patterns of the reflective photomask 210 are measured using unit aperture areas 127 located at offset distances d between 0.1 and 0.5, are shown. Thus, when the beam shaping part 123J having unit aperture areas 127 located at an offset angle θ of 90° and offset distances d between 0.1 and 0.5 is used, the critical dimension of the pattern of the reflective photomask 210 may be relatively accurately measured using the DUV light.

Referring again to FIGS. 4A to 4J, according to some example embodiments of the inventive concept, when the beam shaping parts 123A to 123J having various unit apertures or apertures by combing various offset angles θ and various offset distances d, are used, it can be understood that the critical dimensions of the patterns of the reflective photomask 210 using the DUV light may be measured within a range with a linear measured result.

Referring again to FIGS. 4A to 4J, it can be understood that there are ranges with a commonly linear measured result. The ranges with a commonly linear measured result may be varied according to the size of critical dimensions of the reflective photomask 210. Accordingly, when critical dimensions of the patterns of the reflective photomask 210 are varied, the beam shaping parts 120, 120A, 120B, 121A, 121B, 122A-122E and 123A-123J, which show a linear measured result within a tolerance of uniformity of the critical dimension, may be selected using some example embodiments of the inventive concept. Therefore, the critical dimensions of the patterns of the reflective photomask 210 may be relatively accurately measured.

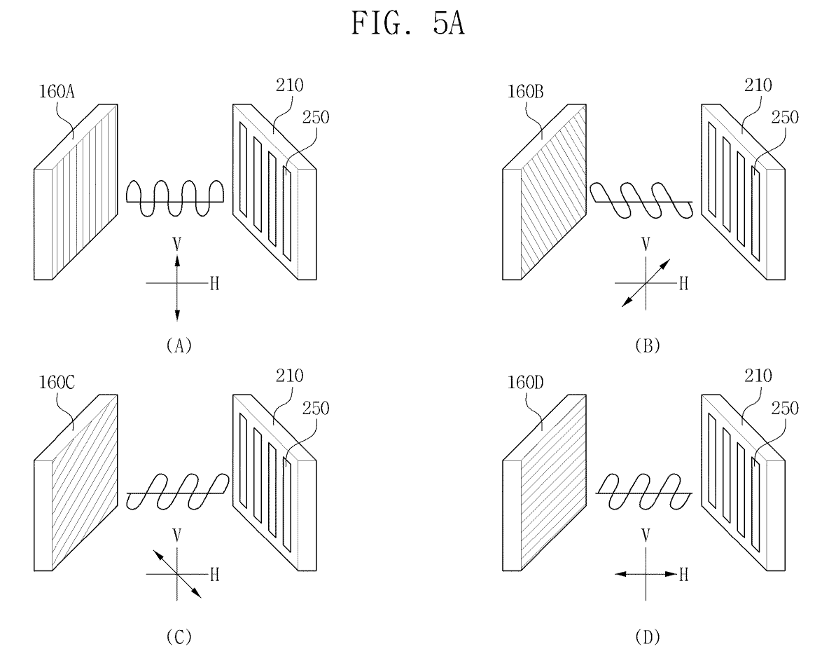

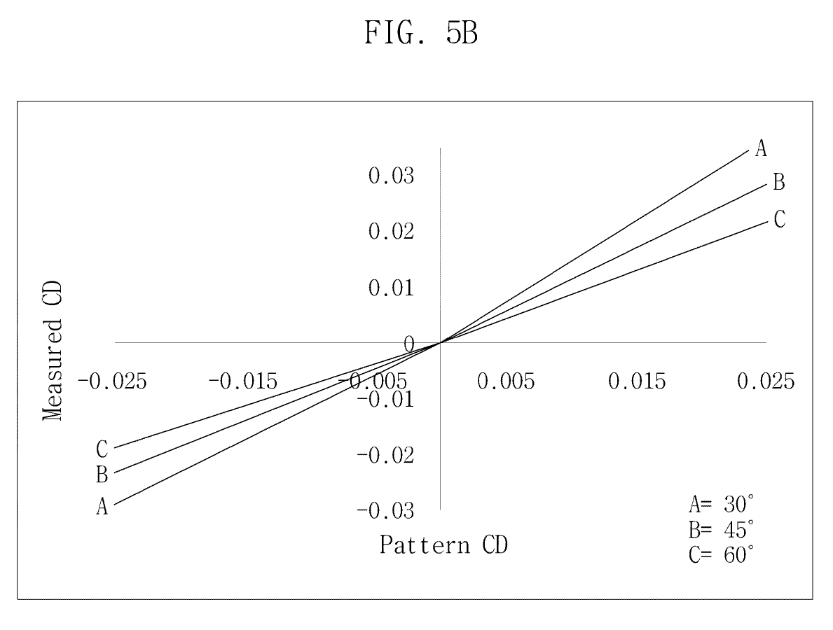

FIG. 5A is a conceptual diagram explaining that a polarization control part 160 adjusts a polarization angle of DUV light, in an apparatus for inspecting and/or measuring a reflective photomask 210 according to some example embodiments of the inventive concept. Referring to (A) of FIG. 5A, a polarization angle passed through a polarization control part 160A may be parallel to a direction extending the line and space pattern 250 of the reflective photomask 210. Referring to (B) and (C) of FIG. 5A, DUV light passed through polarization control parts 160B and 160C may be formed by ±45° to the direction extending a line and space pattern 250 of the reflective photomask 210. Referring to (D) of FIG. 5A, DUV light passed through a polarization control part 160D may be formed by 90° to the direction extending the line and space pattern 250 of the reflective photomask 210.

FIG. 5B is a graph showing the measured results of a critical dimension of a pattern of a reflective photomask 210 according to a polarization angle, in an apparatus for inspecting and/or measuring a reflective photomask 210 according to some example embodiments of the inventive concept. The graph shows results of measuring critical dimensions of line and space patterns of the reflective photomask 210 by splitting the polarization angle into 30°, 45°, and 60°, by assuming that the polarization angle is set 0° when it is the same as a direction to which a line and space pattern of the reflective photomask 210 extends and is set 90° when it is orthogonal to the direction. Referring to FIG. 5B, generally linear measured results are shown. In particular, when the polarization angle is 60°, a relatively more linear measured result is shown. Therefore, according to some example embodiments of the inventive concept, if the polarization angle is variously adjusted according to the critical dimension, it can be understood that a measured result of the critical dimension can be obtained more accurately.

As a result, when the apparatus for measuring the reflective photomask according to some example embodiments of the inventive concept is used, since a critical dimension of a pattern of the reflective photomask may be relatively accurately measured using DUV light, processing costs of measuring the critical dimension of the pattern of the reflective photomask are inexpensive, and the process can be performed quickly and accurately.

While example embodiments have been particularly shown and described, it will be understood by those of ordinary skill in the art that various changes in form and details may be made therein without departing from the spirit and scope of the present invention as defined by the following claims.

What is claimed is:

1. An apparatus for measuring patterns on a reflective photomask, the apparatus comprising:
a light illuminating part including a light source, configured to generate light, and a beam shaping part;
a photomask stage located to cause the light generated from the light source to be incident at an angle through the beam shaping part; and
a light detector configured to receive optical image information of the reflective photomask mounted on the photomask stage.

2. The apparatus according to claim 1, wherein the light incident to the photomask stage through the beam shaping part has an angle with respect to a normal line of a surface of the photomask stage.

3. The apparatus according to claim 1, wherein the light illuminating part further includes a polarization control part.

4. The apparatus according to claim 1, wherein the light source is configured to generate deep ultra violet (DUV) light having a wavelength of about 193 nm.

5. The apparatus according to claim 1, wherein the beam shaping part includes an optical aperture.

6. The apparatus according to claim 1, further comprising:
a minor between the light illuminating part and the photomask stage.

7. The apparatus according to claim 6, wherein the minor includes a semitransparent mirror.

8. The apparatus according to claim 1, further comprising:
a slit plate between the light illuminating part and the photomask stage.

9. The apparatus according to claim 8, wherein the slit plate includes a slit of a bar shape, and
wherein the photomask stage and the light detector are configured to move in a direction perpendicular to the slit.

10. The apparatus according to claim 1, wherein the light illuminating part further includes a relay lens between the light source and the beam shaping part.

11. The apparatus according to claim 1, wherein the light detector includes a charge coupled device (CCD).

12. The apparatus according to claim 1, further comprising:
a pupil lens between the photomask stage and the light detector.

13. An apparatus for measuring patterns on a reflective photomask, the apparatus comprising:
a light illuminating part including a light source configured to generate light and configured to adjust a progress direction of the light generated from the light source at an angle;
a photomask stage in a direction at which the light is irradiated from the light illuminating part at the angle and configured to mount the reflective photomask;
a slit plate between the light illuminating part and the photomask stage; and
a light detector configured to receive image information of the reflective photomask mounted on the photomask stage.

14. The apparatus according to claim 13, wherein the light illuminating part further includes a beam diffractor.

15. The apparatus according to claim 14, wherein the beam diffractor includes a grating mask.

16. An apparatus for measuring patterns on a reflective photomask, the apparatus comprising:
a light illuminating part that includes a light source configured to generate DUV light;
a photomask stage configured to mount the reflective photomask; and
a light detector configured to receive the DUV light from the light illuminating part that is reflected from the reflective photomask mounted on the photomask stage;
wherein the light illuminating part is configured to cause the DUV light from the light illuminating part to be incident on the reflective photomask at angles other than normal to the reflective photomask.

17. The apparatus according to claim 16, further comprising:
a beam shaping part;
wherein the beam shaping part includes an optical aperture.

18. The apparatus according to claim 16, further comprising:
a minor between the light illuminating part and the photomask stage.

19. The apparatus according to claim 16, further comprising:
a semitransparent minor between the light illuminating part and the photomask stage.

20. The apparatus according to claim 16, further comprising:
a slit plate between the light illuminating part and the photomask stage.
